(19) United States
(12) Patent Application Publication
(10) Pub. No.: US 2025/0235847 A1
(43) Pub. Date: Jul. 24, 2025

(54) AQUEOUS SORBENT CONTAINING AMINE AND METAL SALT FOR CAPTURE OF CARBON DIOXIDE

(71) Applicant: UT-Battelle, LLC, Oak Ridge, TN (US)

(72) Inventors: Gyoung Gug Jang, Knoxville, TN (US); Radu Custelcean, Knoxville, TN (US); Gang Seob Jung, Knoxville, TN (US); Jong K. Keum, Knoxville, TN (US); Jiho Seo, Buford, GA (US); Constantinos Tsouris, Oak Ridge, TN (US); Mina Yoon, Knoxville, TN (US)

(21) Appl. No.: 19/027,854

(22) Filed: Jan. 17, 2025

Related U.S. Application Data
(60) Provisional application No. 63/622,850, filed on Jan. 19, 2024.

(51) Int. Cl. B01J 20/22; B01D 53/02; B01D 53/62; B01J 20/34

(52) U.S. Cl. CPC B01J 20/22; B01D 53/02; B01D 53/62; B01J 20/3425; B01J 20/3483; B01D 2257/504

(57) ABSTRACT

A method for capturing carbon dioxide, by: (i) contacting carbon dioxide gas with an aqueous solution containing: (a) an aqueous solvent, (b) an amine-containing sorbent of the formula H₂N—(CR₂)ₙ—NH₂, wherein n is an integer of 3-12 and R is independently selected from H, CH₃, CH₂CH₃, (CH₂)ₘOH, and (CH₂)ₚNH₂ for each instance of R, wherein m and p are independently selected from 0-3; and (c) a monovalent or divalent metal salt of the formula M^{a}_{c}X^{b}_{d} where M is a monovalent or divalent metal, X is an anion other than carbonate or bicarbonate, a is +1 or +2, b is −1 or −2, and a·c=b·d; wherein the contacting step results in precipitation of a complex carbamate salt of the formula H₂N—(CR₂)ₙ—NHC(O)O⁻M^{a} and/or a complex dicarbamate salt of the formula M^{a}-O(O)CHN—(CR₂)ₙ—NHC(O)O⁻M^{a}; and (ii) separating the precipitated solid from the aqueous solvent, optionally followed by thermal regeneration of the amine-containing sorbent.

### CROSS REFERENCE TO RELATED APPLICATION

The present application claims benefit of U.S. Provisional Application No. 63/622,850, filed on Jan. 19, 2024, all of the contents of which are incorporated herein by reference.

### STATEMENT REGARDING FEDERALLY SPONSORED RESEARCH

This invention was made with government support under Prime Contract No. DE-AC05-00OR22725 awarded by the U.S. Department of Energy. The government has certain rights in the invention.

### FIELD OF THE INVENTION

The present invention generally relates to materials and methods for capturing carbon dioxide. The present invention more particularly relates to the capture of carbon dioxide using aqueous sorbent solutions containing amine sorbent molecules for production of carbamate, bicarbonate, and carbonate salts of such sorbents.

### BACKGROUND

Among typical carbon dioxide (CO₂) separation processes, solvent-based CO₂ absorption is the most mature and commonly adopted due to its higher efficiency and lower cost compared to other processes. For example, the cost of an aqueous absorption process (e.g., monoethanolamine (MEA), diethanolamine, or potassium carbonate) for post-combustion capture from a coal-fired power plant was estimated to be $34/tonne CO₂ captured (Hendriks C. Energy conversion: CO₂ removal from coal-fired power plant. Netherlands: Kluwer Academic Publishers; 1995). Solvent-based CO₂ absorption, however, is also considered one of the most energy-intensive CO₂ capture methods because solvent regeneration requires substantial thermal energy for CO₂ removal, which is the largest contributor to the process operating cost. A traditional amine-based CO₂ capture solvent (e.g., 30 wt. % MEA in water) requires relatively large amounts of thermal energy for heating the solvent during the regeneration process. For example, the specific energy requirement of aqueous MEA has been estimated to be 3.75-11.2 GJ/ton CO₂ (R. Notz et al., Int. J. Greenh. Gas Control 6 (2012) 84-112).

In contrast to the liquid absorption process, adsorption uses a solid sorbent to bind the CO₂ on its surface. Adsorption has some advantages, such as no liquid waste, and low cost of raw material. In the adsorption process, CO₂ is preferentially adsorbed on the surface of a solid adsorbent at high pressure (i.e., pressure swing adsorption, PSA) or high temperature (i.e., temperature swing adsorption, TSA). Then, the system containing the CO₂-saturated sorbent will swing to low pressure (usually atmospheric pressure) to release the CO₂ for subsequent compression and transport and regenerate the adsorbent for the next cycle. The operating cost of a specific TSA process was estimated to be $80-150/tonne CO₂ captured (A. R. Kulkami et al., Ind. Eng. Chem. Res. 2012; 51:8631-45). Recently, membrane gas separation has been gaining increased scrutiny as a promising alternative approach, with a cost estimated at $54-82/tonne CO₂ captured (M. T. Ho et al., Ind. Eng. Chem. Res., 2008; 47 (5), 1562-1568).

Although solvent-based absorption is currently the most cost-effective technology for CO₂ capture from point sources, the cost remains impractically high. For this reason, there has been much effort in further reducing the cost of CO₂ capture to make it more attractive for industrial scale deployment, such as by exploring different solvent mixtures, such as amine/ammonia-based solvents, nanofluids, water-lean solvents, and non-aqueous solvents. In addition to reducing the cost of the process, an ideal solvent-based sorbent should have a high CO₂ absorption capacity, fast reaction rate, low corrosivity, high thermal and chemical stability, low vapor pressure, and low regeneration heat duty. However, a lower cost sorbent with such favorably properties has remained elusive.

### SUMMARY

The present disclosure describes a solvent-based method for capturing carbon dioxide by use of a specialized liquid sorbent, as further described below. The capture method is advantageously highly efficient and cost effective. The method is further advantageous in that a low temperature regeneration step can be integrated into the process by simple low-cost means. More particularly, the method can achieve a substantially faster regeneration rate (e.g., two, three, four, or five times) compared to convection heating methods. The method described herein substantially simplifies the overall CO₂ capture process and reduces energy costs compared to conventional CO₂ capture and regeneration methods. The method described herein also advantageously provides a high CO₂ absorption capacity, fast reaction rate, low corrosivity, high thermal and chemical stability, low vapor pressure, and low regeneration heat duty.

In the method, carbon dioxide is captured in the aqueous diamine solvent by first forming carbamate and/or bicarbonate salt(s) from polyamine (e.g., diamine, triamine, or tetramine) molecules and CO₂. Then, ions, such as, Na⁺, in the solvent act as a seed to ion-exchange with the carbamate of diamine and form an intermediate ionic complex, triggering self-aggregation to form NaHCO₃ and a solid carbamate oligomer, all of which becomes incorporated into a precipitate. The aggregate and precipitate are formed by a dynamic self-assembly process which is thermally reversible between reactants and product.

More particularly, the method includes the following steps: (i) contacting carbon dioxide gas with an aqueous solution comprising: (a) an aqueous solvent, (b) an amine-containing molecule of the formula H₂N—(CR₂)ₙ—NH₂, wherein n is an integer of 3-12 and R is independently selected from H, CH₃, CH₂CH₃, (CH₂)ₘOH, and (CH₂)ₚNH₂ for each instance of R, wherein m and p are independently selected from 0-3; and (c) a monovalent or divalent metal salt of the formula M^{a}_{c}X^{b}_{d} where M is a monovalent or divalent metal, X is an anion other than carbonate or bicarbonate, a is +1 or +2, b is −1 or −2, and a·c=b·d; wherein the contacting step results in precipitation of a complex carbamate salt of the formula H₂N—(CR₂)ₙ—NHC(O)O⁻M^{a} and/or a complex dicarbamate salt of the formula M^{a-}O(O)CHN—(CR₂)ₙ—NHC(O)O⁻M^{a}; and (ii) separating the precipitated complex carbamate and/or dicarbamate salt from the aqueous solvent. In some embodiments, the precipitated complex also includes a bicarbonate salt, i.e., H₂N—(CR₂)ₙ—NH₃⁺(HCO₃⁻), M⁺(HCO₃), and/or M²⁺(HCO₃)₂, and/or a metal carbonate salt, i.e., M⁺₂(CO₃) or M²⁺(CO₃). The method may also include a regeneration step, step (iii), after step (ii) as follows: subjecting the precipitated complex to an elevated temperature of at least 80° C. and up to 200° C., to result in regeneration of the amine-containing molecule and simultaneous release of the captured carbon dioxide, wherein the released carbon dioxide is quarantined to prevent release into the atmosphere.

Several amine molecules were herein explored to achieve a low-energy, highly selective CO₂ sorbent system. The sorbent system advantageously uses low cost commercial amine ingredients that provide high CO₂ loading. After or during the CO₂ loading, spontaneous precipitation occurs upon contact with a salt (e.g., NaCl). In the method, the formed solids can advantageously be regenerated under mild conditions (e.g., 80-120° C.). Hexane-1,6-diamine (HD), for example, forms a CO₂-diamine-Na aggregate that meets these requirements. Thus, in particular embodiments, the amine is a diamine molecule, such as HD. HD is particularly advantageous by providing a high CO₂ loading (i.e., 1.51 mole CO₂/mole of amine at 0.5 M) and high cyclic capacity (i.e., 0.81 mole CO₂/mole of amine). Besides providing a highly efficient system, the foregoing abilities of HD and other polyamines, coupled with the metal salt, can reduce the solvent circulation rate in the CO₂ absorption process.

Moreover, a key by-product, NaHCO₃ (sodium bicarbonate), has a wide variety of uses, such as, for example, baking soda, which may be used as a cleaning agent or as a pH buffer in the chemical, medical, and pharmaceutical industries. Sodium bicarbonate can also be used as a desulfurization or denitrification agent in flue gas treatment. Sodium carbonate, which also has a number of uses, may also be formed. As further discussed in the Examples section, molecular dynamics (MD) simulations were used to help reveal the mechanisms involved in forming the large carbamate-diamine-Na aggregate solid precipitate observed in the experiments.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 schematically depicts the mechanism of CO₂ capture by a CO₂-diamine-salt network followed by solvent regeneration. Notations (1)-(7) are identified as follows: (1) water containing salt, (2) diamine added to salt water, (3) CO₂ bubbled into the solvent, (4) diamine capturing CO₂ and aggregating with salt, (5) CO₂-diamine-salt aggregate precipitating, and unreacted solvent being separated, (6) mild heating of the solid at 80-120° C. applied to release CO₂, and (7) the salt and diamine dissolving back into unreacted solvent once the CO₂ is released.

FIGS. 2a-2c. FIG. 2a is a photo showing CO₂-HD-NaCl precipitation samples (#1-#9) at different experimental conditions: CO₂ was loaded into 5 mL of aqueous 30 wt % HD solution, and then NaCl was added from #4 (20 g/L) to #9 (120 g/L) in the CO₂-loaded solution with an increasing salt amount (100 mg). FIG. 2b is a graph plotting the corresponding amine concentration of the supernatant solution. FIG. 2c is a graph plotting the amount of CO₂ and corresponding CO₂ removal efficiency from the supernatant.

FIGS. 3a-3b. FIG. 3a is a graph plotting weight loss vs. temperature, and FIG. 3b is a graph plotting heat flow vs. temperature, for the CO₂-HD-NaCl (300 mg) system, CO₂-HD system, and NaHCO₃, as measured by TGA/DSC using a heating rate of 5 K/min.

FIGS. 4a-4d. Depiction of the amine-carbamate-Na complex after 20 ns with 10 wt % amine solution, as generated by molecular dynamics (MD) simulations. The left panel shows aggregates formed from both the diamine and carbamate with Na, while the right panel shows the structure of the diamine molecule used and the resulting carbamate. As the chain length of the diamine decreased from hexane (FIG. 4a) to pentane (FIG. 4b) to butane (FIG. 4c) to propane (FIG. 4d), the size of the aggregate also decreased. Most importantly, the hexane-diamine system showed more amine molecules involved in the complex.

FIGS. 5a-5b. FIG. 5a shows possible atomic-scale mechanisms for the precipitation of the amine-carbamate-Na complex. The carbamate of short amines can only interact with Na⁺, which thus makes formation of a larger-scale cluster more difficult. In the hexane-diamine system, carbamate can interact and be stabilized by van der Waals interaction (red dotted lines) with amine molecules. More neutral amine molecules in the complex prevent the electrostatic interactions of Na⁺ and negative oxygen atoms in carbamates from being concentrated, thus promoting the formation of a larger cluster. FIG. 5b shows the temporal evolution of SASA (solvent accessible surface area) values. FIG. 5c shows corresponding structures (i, ii, iii, iv, v, and vi) in each snapshot of the amine-carbamate complex from the initial configuration, clearly showing the clustering dynamics during the MD simulations.

FIGS. 6a-6d. FIG. 6a shows SEM-EDS (Scanning Electron Microscopy-Energy Dispersive Spectra) of the precipitated solids (CO₂-HD-Na). Red dotted circles indicate NaHCO₃, and yellow dotted circles indicate NaCl. FIG. 6b shows a 13C NMR (Nuclear Magnetic Resonance) spectrum of a CO₂-HD-Na solid specimen, illustrating carbon spectra of the carbonyl group in the range of 164-167 ppm. FIG. 6c shows ¹H/¹³C HECTOR NMR spectrum of a CO₂-HD-Na solid specimen. FIG. 6d shows XRD (X-Ray Diffraction) patterns of the dry precipitated solid and annealed solid at 120° C. for 30 min. CO₂-HD solid precipitation without the presence of NaCl may be obtained when 50 wt % HD aqueous solution is loaded with CO₂. FIG. 6e shows FTIR (Fourier Transformed Infra-Red) spectra during thermal regeneration of the diamine. The peaks at around 500 and 2,500 cm⁻¹ correspond to released CO₂, and the peaks at approximately 1,500 and 4,000 cm⁻¹ correspond to released water vapor.

FIGS. 7a-7b. FIG. 7a schematically depicts the overall chemical reaction during (I) CO₂ absorption, (II) precipitation, and (III) regeneration. FIG. 7b shows the corresponding FTIR spectra: (1) solid HD; (2) aqueous HD without CO₂ captured; (3) aqueous HD with CO₂ captured; (4) CO₂-containing precipitate of (3) (i. e., CO₂-HD-Na) before regeneration; and (5) CO₂-containing precipitate of (3) (i. e., CO₂-HD-Na) after regeneration.

### DETAILED DESCRIPTION

In a first step of the method for capturing carbon dioxide described herein, an aqueous-based carbon dioxide sorbent (i.e., “sorbent” or “solution”) is contacted with carbon dioxide. The sorbent contains at least or solely the following components: (a) an aqueous solvent, (b) an amine-containing molecule containing at least two amino (NH₂) groups, and (c) a monovalent or divalent metal salt, each of which are further described in detail below. In a first set of embodiments, a precursor solution containing components (a) and (b) is first formed, followed by contacting the carbon dioxide gas with the precursor solution, followed by addition of component (c) to the precursor solution. In a second set of embodiments, a precursor solution containing components (a) and (c) is first formed, followed by contacting the carbon dioxide gas with the precursor solution, followed by addition of component (b) to the precursor solution. In a third set of embodiments, a pre-made solution containing components (a), (b), and (c) is first formed, followed by contacting the carbon dioxide gas with the premade solution.

The aqueous solvent (component (a)) of the sorbent is any solvent or solvent mixture containing at least 1 vol % water. In different embodiments, the sorbent may contain at least or greater than 2, 5, 10, 20, 30, 40, or 50 vol % water. In some embodiments, the aqueous solvent is composed completely of water (i.e., 100% water). In other embodiments, the aqueous solvent contains one or more water-soluble organic solvents mixed with water, in which case the aqueous solvent contains less than 100% water. The one or more water-soluble organic solvents may be selected from, for example, alcohols (e.g., methanol, ethanol, and isopropanol), diols (e.g., ethylene glycol or propylene glycol), ketones (e.g., acetone), nitriles (e.g., acetonitrile), lactams (e.g., N-methylpyrrolidinone), THF, DMF, and DMSO. The water-soluble organic solvent is typically present in the solvent mixture in an amount of no more than 90 vol %, 80 vol %, 70 vol %, 60 vol %, 50 vol %, 40 vol %, 30 vol %, 20 vol %, 10 vol %, or 5 vol %, or an amount within a range bounded by any two of the foregoing values (e.g., 5-50 vol %).

The amine-containing molecule (component (b)) of the sorbent can be conveniently delineated by the following formula: H₂N—(CR₂)ₙ—NH₂, wherein n is an integer of 3-12 and R is independently selected from H, CH₃, CH₂CH₃, (CH₂)ₘOH, and (CH₂)ₚNH₂ for each instance of R, and wherein m and p are independently selected from 0, 1, 2, and 3, or a range therein (e.g., 0-3, 0-2, 1-3, or 1-2). Moreover, —NH—, —NR—, and/or —O-linkers may or may not be included in the amine-containing molecule. If one or more linkers provided above is present, each linker interrupts a carbon-carbon bond in the amine-containing molecule. In different embodiments, the value of n may be 3, 4, 5, 6, 7, 8, 9, 10, 11, or 12, or a value within a range bounded by any two of the foregoing values, e.g., 3-10, 3-8, 3-6, 4-12, 4-10, 4-8, or 4-6. In the case where at least one R is (CH₂)ₚNH₂, the amine-containing molecule may be, for example, a triamine, tetraamine, pentaamine, or hexamine. Generally, no more than one or two R groups in the molecule is/are (CH₂)ₚNH₂. In some embodiments, no R group is (CH₂)ₚNH₂ in the molecule, which would thus limit the molecule to the class of diamines. In particular embodiments, R is H for all instances of R. Some particular examples of amine-containing molecules in which all R are H include 1,3-diaminopropane, 1,4-diaminobutane, 1,5-diaminopentane, and 1,6-diaminohexane (hexamethylenediamine). Some examples of amine-containing molecules in which one or more R is other than H (such as any groups provided above) include 1,3-diaminopentane, 1,4-diaminopentane, 1,4-diaminohexane, 1,5-diaminohexane, 1,4-diamino-2-butanol, 1,4-diaminobutane-2,3-diol, diethylenetriamine, 1,3,6-triaminohexane, 1,3,5-triaminohexane, 1,3,5-triaminopentane, triethylenetetramine, N,N′-bis(3-aminopropyl)-1,3-diaminopropane, N,N′-bis(3-aminopropyl)-1,4-diaminobutane, and tris(2-aminoethyl)amine. The amine-containing molecules described above are generally commercially available or can be synthesized by methods well known in the art. In some embodiments, any one or more of the foregoing classes or specific types of amine-containing molecules is/are excluded from component (b).

The amine-containing molecule is typically present in the aqueous solution in a concentration of 5-60 wt %. In different embodiments, the amine-containing molecule is present in an amount of precisely or about, for example, 5, 10, 15, 20, 25, 30, 35, 40, 45, 50, 55, or 60 wt %, or an amount within a range bounded by any two of the foregoing values, e.g., 5-60 wt %, 5-50 wt %, 5-40 wt %, 5-30 wt %, 5-20 wt %, 5-10 wt %, 10-60 wt %, 10-50 wt %, 10-40 wt %, 10-30 wt %, 10-20 wt %, 15-60 wt %, 15-50 wt %, 15-40 wt %, 15-30 wt %, 20-60 wt %, 20-50 wt %, 20-40 wt %, or 20-30 wt %.

The monovalent or divalent metal salt (component (c), i.e., “salt”) of the sorbent can be conveniently delineated by the following formula: M^{a}_{c}X^{b}_{d} where M is a monovalent or divalent metal (cation), X is an anion other than carbonate or bicarbonate, a is +1 or +2, b is −1 or −2, and a·c=b·d. The salt should be fully soluble in the aqueous component (component (a)). Some examples of monovalent metals (M) include the alkali metals (i.e., Li⁺, Na⁺, K⁺, Rb⁺, and Cs⁺), or more typically Na⁺ or K⁺. Some examples of divalent metal ions include the alkaline earth metals (e.g., Mg²⁺, Ca²⁺, Sr²⁺, and Ba²⁺) and others (e.g., Zn²⁺). Anions (X) other than carbonate or bicarbonate may be selected from, for example, halides (e.g., chloride, bromide, or iodide), sulfate, and nitrate. In some embodiments, at least one of the foregoing types of anions is present in the salt, either alone or in combination with one or more other anions. Other less common anions (e.g., sulfite, nitrite, and thiosulfate) may or may not be included. In some embodiments, the anion may be a chelating ligand, particularly if combined with one or more other non-chelating anions, as described above. In other embodiments, chelating anions are excluded, particularly if not accompanied by a non-chelating anion. In some embodiments, the anion is selected from only one or more of the above named anions. Any one or more of the above described monovalent or divalent metal cations may be combined with any one or more of the above described anions to form one or more metal salts as component (c). Some particular examples of metal salts that may be present as component (c) include lithium chloride, lithium bromide, sodium chloride, sodium bromide, magnesium chloride, magnesium bromide, calcium chloride, calcium bromide, zinc chloride, lithium sulfate, sodium sulfate, magnesium sulfate, calcium sulfate, lithium nitrate, sodium nitrate, magnesium nitrate, and calcium nitrate. In some embodiments, any one or more of the above cations, anions, or salts may be excluded from component (c).

The salt is typically present in the aqueous solution in a concentration of 1-200 g/L. In different embodiments, the salt is present in the aqueous solution in a concentration of precisely or about, for example, 1, 5, 10, 20, 30, 40, 50, 60, 70, 80, 90, 100, 120, 150, 180, or 200 g/L. The salt may alternatively be present in an amount within a range bounded by any two of the foregoing values, e.g., 1-180 g/L, 1-150 g/L, 1-120 g/L, 1-100 g/L, 1-60 g/L, 1-20 g/L, 5-200 g/L, 5-180 g/L, 5-150 g/L, 5-120 g/L, 5-100 g/L, 5-60 g/L, 5-20 g/L, 10-200 g/L, 10-180 g/L, 10-150 g/L, 10-120 g/L, 10-100 g/L, or 10-50 g/L.

The carbon dioxide-containing gas making contact with the aqueous sorbent solution can be any source of gas containing carbon dioxide. The gaseous source can be, for example, air, waste gas (i.e., a gaseous waste stream) from an industrial or commercial process, flue gas from a power plant, exhaust from an engine, or gas from a subterranean space (e.g., sewage or landfill gas).

In the first step of the method (i.e., contacting step), carbon dioxide gas is contacted with an aqueous solution containing solely or at least components (a), (b), and (c), each of which has been described in detail above. As a result of the contacting process, a precipitate forms that contains a complex carbamate or dicarbamate salt of the amine-containing molecule (component (b)). The carbamate salt can be expressed by the simplified formula H₂N—(CR₂)ₙ—NHC(O)O⁻M^{a}, while the dicarbamate salt can be expressed by the simplified formula M^{a-}O(O)CHN—(CR₂)ₙ—NHC(O)O-M^{a}, wherein M is a monovalent or divalent metal, which corresponds to a=+1 or +2, respectively. Notably, in the case where M^{a} represents a divalent metal, the divalent metal will necessarily need to bind to more than one carbamate group and thus form an extended framework, contrary to the simplified formulas provided above for the carbamate and dicarbamate salts. An extended framework is also possible for monovalent metal salts. In some embodiments, the precipitated complex carbamate salt further contains an ammonium bicarbonate salt of the formula H₂N—(CR₂)ₙ—NH₃⁺(HCO₃⁻), and/or a metal bicarbonate salt of the formula M^{a}(HCO₃⁻)_{d}, wherein a=d. A bis-bicarbonate salt may also be present, e.g., of the formula (HCO₃⁻) H₃N⁺—(CR₂)ₙ—NH₃⁺(HCO₃⁻). In some embodiments, an ammonium carbonate salt may be present, which may have the formula [—(CR₂)ₙ—NH₃⁺(CO₃)H₃N⁺-]ᵣ, wherein r indicates a great multiplicity (typically at least or greater than 10, 50, or 100), such as found in a polymer.

In a second step of the method, the precipitated complex carbamate and/or dicarbamate (precipitated solid) is separated from the aqueous solvent. The precipitated solid can be separated from the solution by any of the methods well known in the art, such as by filtration, centrifugation, decanting, or a combination of any of these. In particular embodiments, the precipitated solid is separated from the solution by centrifugation (e.g., at 2500-3500 rpm for 5-15 minutes) followed by decanting of the liquid or filtration. After the precipitated solid is separated from the solution, it is typically dried by any of the drying methods known in the art, such as by exposure to a mild elevated temperature (e.g., above room temperature and up to or below 40, 50, 60, 70, or 80° C.) under reduced pressure for a period of at least 6, 12, or 24 hours. As well known, room temperature typically corresponds to a temperature of 18-30° C. or about 25° C.

In some embodiments, the method further includes a subsequent step to regenerate the amine-containing sorbent and release the captured carbon dioxide from the sorbent for storage (quarantining) and/or use. The regeneration step may be referred to as step (iii). The storage of the carbon dioxide typically involves pressurizing the carbon dioxide in a suitable vessel. The released carbon dioxide may be indefinitely stored or it may ultimately be used, such as in a chemical process where carbon dioxide is used as a feedstock and converted to hydrocarbons or other chemical products (e.g., methanol or ethanol) or where the released carbon dioxide gas is converted to supercritical carbon dioxide or dry ice.

The regeneration step may be accomplished by, for example, subjecting the precipitated solid (typically dried) to an elevated temperature of at least or above 80° C. and up to or less than 200° C., to result in regeneration of the amine-containing molecule and simultaneous release of the captured carbon dioxide, wherein the released carbon dioxide is quarantined to prevent release into the atmosphere. In different embodiments, the precipitated solid is subjected to a temperature of precisely or about, for example, 80° C., 85° C., 90° C., 95° C., 100° C., 110° C., 120° C., 130° C., 140° C., 150° C., 160° C., 170° C., 180° C., 190° C., or 200° C., or a temperature within a range bounded by any two of the foregoing values, such as 80-200° C., 80-180° C., 80-150° C., 80-120° C., 80-100° C., 90-200° C., 90-180° C., 90-150° C., 90-120° C., 90-100° C., 100-200° C., 100-180° C., 100-150° C., 100-120° C., 110-200° C., 110-180° C., 110-150° C., 120-200° C., 120-180° C., or 120-150° C. In some embodiments, the temperature employed may be above 200° C., such as a temperature of 210° C., 220° C., 230° C., 240° C., or 250° C., or the temperature may be within a range in which any of the temperatures at or below 200° C. provided above functions as a minimum and any of the foregoing exemplary temperatures above 200° C., functions as a maximum. In some embodiments, a temperature of above 128° C. (e.g., at or above 130° C. or 140° C.) is employed in order to convert carbamate groups or bicarbonate in the precipitated solid to carbonate. The regeneration step may be accomplished by means other than exposing the precipitated solid to an elevated temperature. For example, the precipitated solid may be exposed to infrared radiation, ionizing radiation, or a reduced pressure (i.e., less than 1 atm), any of which may or may not be used in tandem with a low elevated temperature (e.g., 30, 40, 50, 60, or 70° C., or within a range therein).

In some embodiments, the regenerated amine-containing molecule is re-used for additional capture of carbon dioxide according to the method described above. More specifically, the regenerated amine-containing molecule may be dissolved in an aqueous solvent, as described above, along with a monovalent or divalent metal salt, as described above, to form an aqueous sorbent solution that forms a precipitated complex carbamate and/or dicarbamate salt with carbon dioxide when the solution is contacted with carbon dioxide, as described above. The aqueous solvent may also be re-used to make the method further efficient. The regenerated amine may then form a second crop of precipitated solid, which may then be separated from the solvent, as described above, and the solid dried and subjected to an elevated temperature to result in regeneration of the amine-containing sorbent and simultaneous release of the captured carbon dioxide, as described above. The re-used amine-containing sorbent and/or solvent may be re-used again, and the process may be repeated indefinitely any number of times.

Examples have been set forth below for the purpose of illustration and to describe certain specific embodiments of the invention. However, the scope of this invention is not to be in any way limited by the examples set forth herein.

### EXAMPLES

### Overview

In the following experiments, a solid CO₂ sorbent matrix was developed for low regeneration energy by forming a CO₂-amine-metal aggregate solid. Carbon dioxide was captured in the aqueous diamine solvent by first forming carbamate and bicarbonate. Then, Na⁺ ions in the solvent act as a seed to ion-exchange with the carbamate of diamine to form an intermediate ionic complex, thus triggering self-aggregation to form NaHCO₃ and solid carbamate oligomer. The process is based on a dynamic self-assembly and is thermally reversible.

Several amine molecules were explored to select a low-energy, highly selective CO₂ sorbent system having the following attributes: low cost for commercial amine ingredients with high CO₂ loading; amines soluble in an aqueous solvent before CO₂ loading; spontaneous precipitation occurring as soon as a third component (e. g., NaCl, CO₂) is introduced into the system; and solids formed can be regenerated under mild conditions (e. g., 80-120° C.). Hexane-1,6-diamine (HD) forms a CO₂-diamine-Na aggregate that meets these requirements. This water-soluble diamine has high CO₂ loading (i. e., 1.51 mole CO₂/mole of amine at 0.5 M) with high cyclic capacity (i. e., 0.81 mole CO₂/mole of amine), which can reduce the solvent circulation rate in the CO₂ absorption process. Thus, HD may be suitable for point-source capture. Also, compared to the bis-iminoguanidine (BIG) system, the CO₂-HD-Na system does not divert energy to the vaporization of water since the CO₂ fixation system is non-aqueous and HD does not face additional complexities encountered by BIG systems. Moreover, the by-product, NaHCO₃, has a very wide variety of uses; for example, it can be used as baking soda, as a cleaning agent, or as a pH buffer in the chemical, medical, and pharmaceutical industries. It can also be used as a desulfurization or denitrification agent in flue gas treatment. As further discussed below, molecular dynamics (MD) simulations helped elucidate the solid precipitation behavior observed in the experiments and revealed the governing mechanisms for the formation of a large carbamate-diamine-Na aggregate.

### Method for CO₂-Derived Precipitation

Various reagents, such as ethanolamine, ethylenediamine, 1,3-diaminopropane, butane-1,4-diamine, and pentane-1,5-diamine, HD, were obtained from commercial sources and were used without further purification. Various concentrated aqueous diamine solutions (10-30 wt %) were prepared with alkyl-derivative amine molecules to explore solidification via formation of the CO₂-diamine-Na aggregate. The CO₂-diamine-Na aggregate was formed by sparging pure CO₂ (99.9%) into 50 mL of aqueous diamine solution for 10 min. After the solvent was cooled to room temperature, CO₂ loading was continued for another 10 min to fully load the solvent at room temperature. Then, a chloride salt (e. g., Li⁺, Na⁺, K⁺, Mg²⁺, Ca²⁺) was added to the CO₂-loaded amine solvent under mechanical stirring until full dissolution. To investigate the influence of the mixing sequence, the diamine solution was added to a salt solution at a concentration of 5-20 wt %. Then, pure CO₂ was sparged to 5 or 20 mL of the diamine/salt solution for 10 min. The CO₂ loading procedure was continued for another 10 min. All mixtures were stored overnight for precipitation to occur. After solid agglomeration, the solid was separated by a centrifuge at 3,000 rpm for 10 min. All samples were dried at 60° C. overnight in a vacuum oven before additional measurements. Scanning electron microscopy (SEM), energy-dispersive x-ray spectroscopy (EDS), x-ray diffraction (XRD), solid-state nuclear magnetic resonance (NMR), Fourier-transform infrared (FTIR), thermal energy measurements, and computational modeling were performed on the precipitated solid.

### Results and Discussion

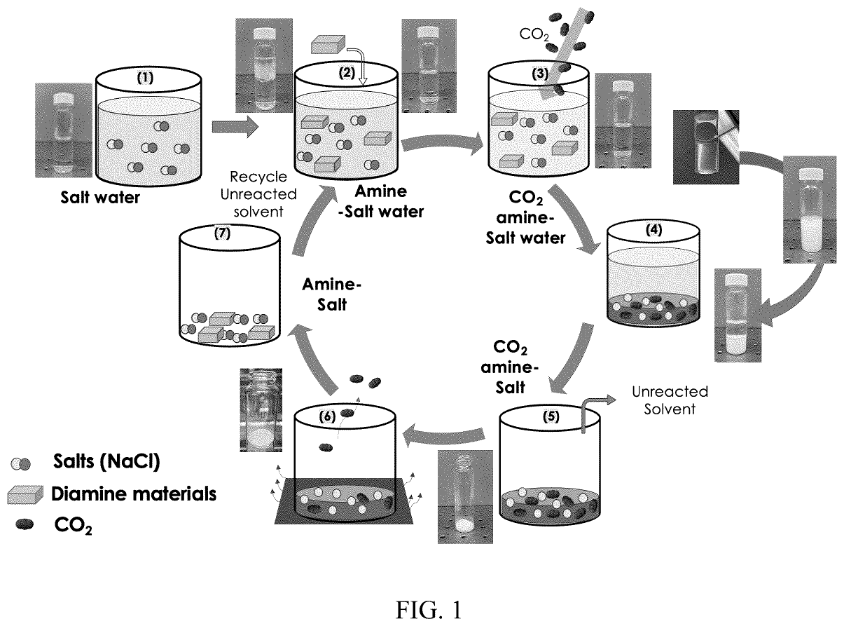

Carbon dioxide capture, precipitation, and solvent regeneration: FIG. 1 shows a schematic of the novel CO₂ capture route via formation of phase-changing CO₂-diamine-Na solid aggregate, which requires low regeneration energy because it eliminates the bulk water heating need in the regeneration process. A commercially available alkyl diamine (i. e., HD) was used to form a CO₂-responsive unit for CO₂ capture. The diamine binds with the absorbed CO₂ to form reactive carbamate and/or carbonate ions and thereafter absorbs metal ions from added salts, thereby resulting in a solid precipitate that can be easily separated from the solution. The CO₂ in the solid can be removed by mild heating, and then the amine and salt are released, thereby permitting the chemicals to be recycled for subsequent CO₂ capture cycles. In general, CO₂ readily combines with diamines at ordinary temperatures and pressures to form carbamates, bicarbonate, or carbonate salt of ammonium cations, in which two amine molecules are held together by an ionic salt bridge. A divalent metal ion salt would more easily bridge two ends but would require higher energy to separate and reuse the diamine compound. The following work elucidates the role of monovalent metal ion salts to self-assemble the diamine derivatives, such as carbamate, bicarbonate, and carbonate, to form a precipitated solid. This work also describes the subsequent separation of CO₂ and the associated energy use for the recovery of chemicals.

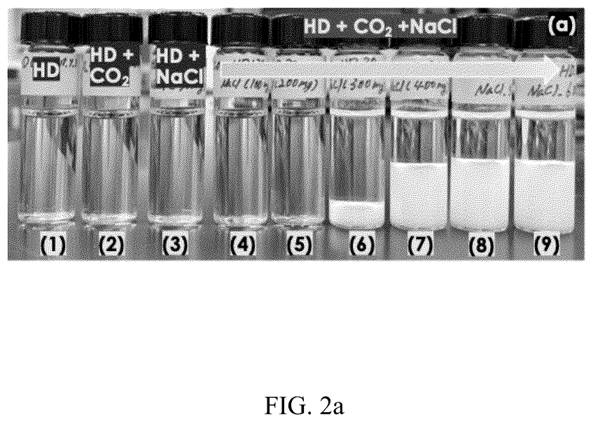

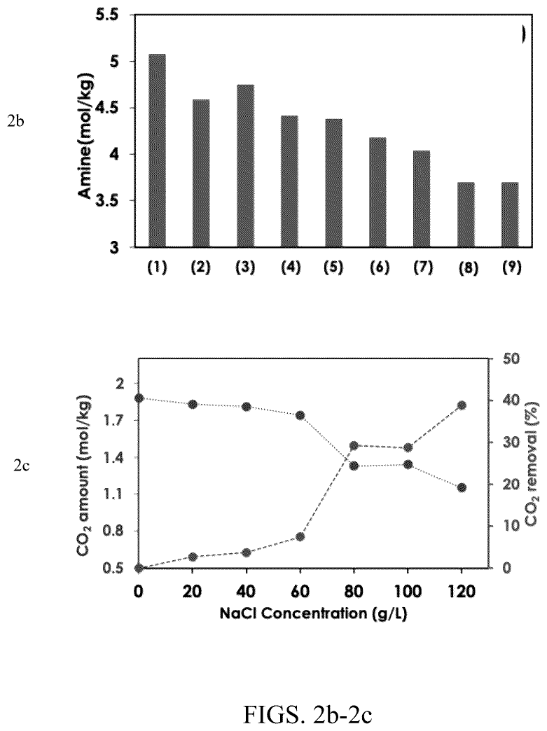

Formation of precipitating CO₂-HD-Na aggregate: FIGS. 2a-2c show the results of solid precipitation by interaction between the NaCl- and CO₂-loaded HD solutions. As shown in FIG. 2a, adding CO₂ or NaCl in an aqueous 30 wt % HD solution did not show any solid precipitation overnight, whereas adding NaCl in the CO₂-loaded HD solution showed solid precipitation above a certain concentration of NaCl (i. e., #6 in FIGS. 2a and 2b is equivalent to 60 g of NaCl per liter). When NaCl was added in the solution, the salt was completely dissolved and the transparent solution changed to white within 30 min. Complete solid/liquid phase separation by agglomeration occurred overnight. FIGS. 2b and 2c show the measured amine concentration and dissolved CO₂ concentration in the supernatant of the samples. The amine and dissolved CO₂ in the supernatant significantly decreased as more solid precipitated at higher NaCl concentrations. This behavior indicates that carbamate and/or carbonate ions in the solution interact with dissolved Na⁺ and precipitate as solid. As shown in FIG. 2c, the CO₂ removal from the solution by solid precipitation reached ˜40% at 120 g/L NaCl. A similar precipitation behavior was also observed when CO₂ was added to an aqueous solution of HD and NaCl (FIG. 2a). Various diamine molecules (e. g., ethanolamine, 1,3-diaminopropane, butane-1,4-diamine, pentane-1,5-diamine) were tested by the same procedure, and only HD showed solid precipitation within 30 minutes.

The large-scale atomic simulation revealed that the electrostatic interactions of Na⁺ and negative oxygen atoms in carbamates initiate the aggregation of the carbamate-Na ionic bonds. However, a larger cluster cannot be formed without amine molecules. The van der Waals (vdW) interaction between hexane-carbamate and hexane-diamine molecules allows for the formation of a larger cluster in the form of a solid phase by preventing ions from being concentrated, whereas shorter diamine molecular systems cannot form such large clusters with the diamine molecules due to the weaker vdW interactions.

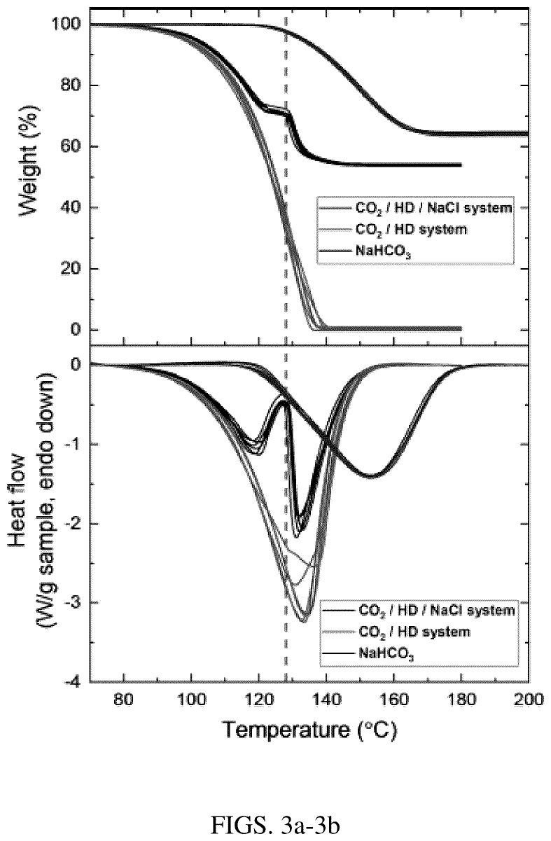

Carbon dioxide regeneration energy from the CO₂-containing precipitate: The high thermal energy required to regenerate CO₂-containing aqueous amine solution has been a great challenge for amine-based CO₂ capture technology. Most regeneration energy is consumed for water vaporization during the regeneration process because the temperature of solvent regeneration is near the boiling point of the solvent, and because of the relatively high heat capacity and enthalpy of vaporization of water. In an effort to circumvent this substantial energy drain, a centrifugal process was herein employed for solid/liquid phase separation prior to regeneration. To quantitatively evaluate the degree of regeneration energy reduction, the weight loss and corresponding heat flow of the CO₂-HD-Na solid system was monitored at elevated temperatures and compared to the results of the CO₂-HD system and NaHCO₃, which are expected to be by-products of the thermal decomposition of the CO₂-HD-Na system. FIG. 3a is a plot of the weight loss for the CO₂-HDNaCl (300 mg) system, CO₂-HD system, and NaHCO₃, as measured by TGA/DSC with a heating rate of 5 K/min. FIG. 3b is a plot of the corresponding heat flow vs. temperature. Notably, CO₂-HD solid precipitation in the absence of NaCl could be obtained when 50 wt % HD aqueous solution was loaded with CO₂, whereas the 30 wt % HD aqueous solution did not produce any precipitate, as shown in FIG. 2a.

Both CO₂-HD and CO₂-HD-NaCl systems began to exhibit weight loss above 80° C. The CO₂-HD system demonstrated a single-step regeneration process (red in FIGS. 3a and 3b), whereas the CO₂-HD-NaCl system exhibited a distinct two-step regeneration process (black in FIGS. 3a and 3b) when heated from 30 to 250° C. at a heating rate of 5° C./min. The transition between the regeneration steps for the CO₂-HD-NaCl system was observed around 128° C. This transition temperature was similar to the point at which NaHCO₃ began to decompose into Na₂CO₃ (blue in FIGS. 3a and 3b). Therefore, the low-temperature regeneration that occurs between 8° and 120° C. is likely a result of CO₂ evolution from carbamate, as well as the loss of HD on heating, whereas the high-temperature regeneration that occurs beyond 128° C. is likely caused by the conversion of NaHCO₃ to Na₂CO₃.

The ratio of organic CO₂-HD and inorganic NaHCO₃ in the CO₂-HD-NaCl system can be affected by the reaction time and scale. At a large-scale reaction (e. g., 50 mL of aqueous 30% HD solution), the portion of organic CO₂-HD appears to be much higher than for a smaller-scale reaction (e. g., 5 mL). As a result, the remaining amount of Na₂CO₃ above 200° C. is ˜10 wt. %. Due to the larger portion of organics, the two-step TGA profiles and DSC peaks were merged into a single degradation profile and a single peak, respectively. The residual solid (e. g., Na₂CO₃, melting point=851° C.) was completely thermally degraded beyond 800° C.

Using the weight loss and corresponding thermal energy for the conversion, the total thermal energy for CO₂ regeneration was calculated and the results presented in Table 1 below. The data includes the CO₂ content, heat of desorption, sensible heat, and heat of vaporization of the samples.

TABLE 1
Comparison of regeneration energy requirements for various solid sorbents

| | | | | | Regen. | CO₂ loading | |
|---|---|---|---|---|---|---|---|
| | ΔH_{Desorption} | ΔH_{Sensible} | ΔH_{vapor.} | ΔHₜₒₜₐₗ | temp. | (mmol CO₂/g- | Estimation |
| Sorbent | (GJ/t CO₂) | (GJ/t CO₂) | (GJ/t CO₂) | (GJ/t CO₂) | (° C.) | sorbent) | method |
| CaCO₃ | 4.1 | 2.2 | — | 6.3 | 900 | 10_{rich} to 0ₗₑₐₙ | — |
| Methylglyoxal- | 6.3 | 1.1 | 2.8 | 10.2 | 100-120 | 4.1_{rich} to 0ₗₑₐₙ | DSC |
| bis(iminoguanidine) | | | | | | | |
| Glyoxal- | 2.8 | 0.7 | — | 3.5 | 100-120 | — | DSC |
| bis(iminoguanidine) | | | | | | | |
| NaHCO₃ | 2.8 | 0.7 | 0.9 | 4.4 | 80-200 | 11.9_{rich} to 5.9ₗₑₐₙ | DSC |
| | 4.7 | 0.7 | 0.9 | 6.3 | | | Experimental |
| | 3.2 | 0.7 | 0.9 | 4.8 | | | Theoretical |
| CO₂-HD-Na | 4.0 | 2.5 | — | 6.5 | 80-200 | 5.6_{rich} to 0.94ₗₑₐₙ | DSC |
| (this work) | — | — | — | — | — | (6.0_{rich}-7.2_{rich}) | |
| | | | | | | to 3.76ₗₑₐₙ | |
| CO₂-HD | 2.2-3.5 | 0.7-1.9 | — | 2.9-5.4 | 80-200 | 5.1_{rich}-6.2_{ric}h | DSC |
| (this work) | | | | | | | |

The CO₂-HD-NaCl system required a regeneration energy of 6.5-8.6 GJ/t CO₂, while the CO₂-HD system required 2.9-5.4 GJ/t CO₂. The higher regeneration energy of the CO₂-HD-Na system compared to that of CO₂-HD is presumably due to a higher decomposition energy required for conversion of NaHCO₃ to Na₂CO₃. All regeneration energies calculated in this study were obtained after the removal of the aqueous solution via a centrifugal process. The CO₂-HD solids reported herein appear to require significantly less regeneration energy compared to conventional solid sorbents.

Precipitation mechanism for the CO₂-HD-Na aggregate: In an effort to understand the mechanism involved in the solid precipitation with HD, molecular dynamic (MD) simulations were performed. From the trajectories of the molecules, solvent accessible surface area (SASA) values were obtained. The SASA values are a measure of the contact area between molecules and solvents. SASA analysis can be used to describe dynamic changes of complex systems, such as proteins, in solution. The approach can capture the structural changes based on the localized information of molecules. One may consider the evolution of vdW or Coulombic energies in an in-depth analysis. However, it is difficult to capture the local information of molecules due to the relatively long radius cutoffs of vdW (˜12 Å) and charge interaction (>12 Å). On the other hand, SASA only accounts for a short interaction (˜2 Å). High SASA values indicate that the molecules are well dissolved in the solvent, whereas low values or a descending trend indicate aggregation.

SASA values of amines, carbamates, and amines-carbamates were used to identify the contributions of amine molecules in the aggregation, which provides in-depth insight on the interaction between the length of amine molecules and the clustering behavior in the experiments. First, 30 wt % diamine solutions were developed in full-atomistic simulations to confirm that all diamine molecules were well dissolved. Then, the diamine-carbamate-NaCl system was developed to better understand the mechanism of precipitation observed in the present experiments. Instead of using pure diamine molecules, half of the diamine molecules were replaced with carbamate (50%) in a 5 wt % NaCl solution. Na⁺ was added to compensate for the negative charges of the carbamate molecules. From NPT simulations performed for 20 ns with a 1 fs time step, it was observed that oxygen in the carbamates interacted mainly with Na⁺.

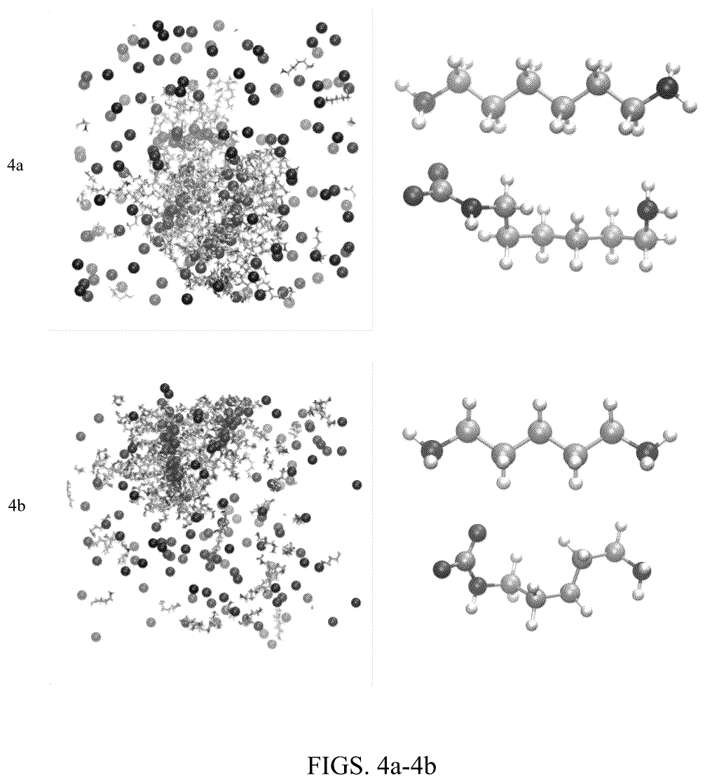

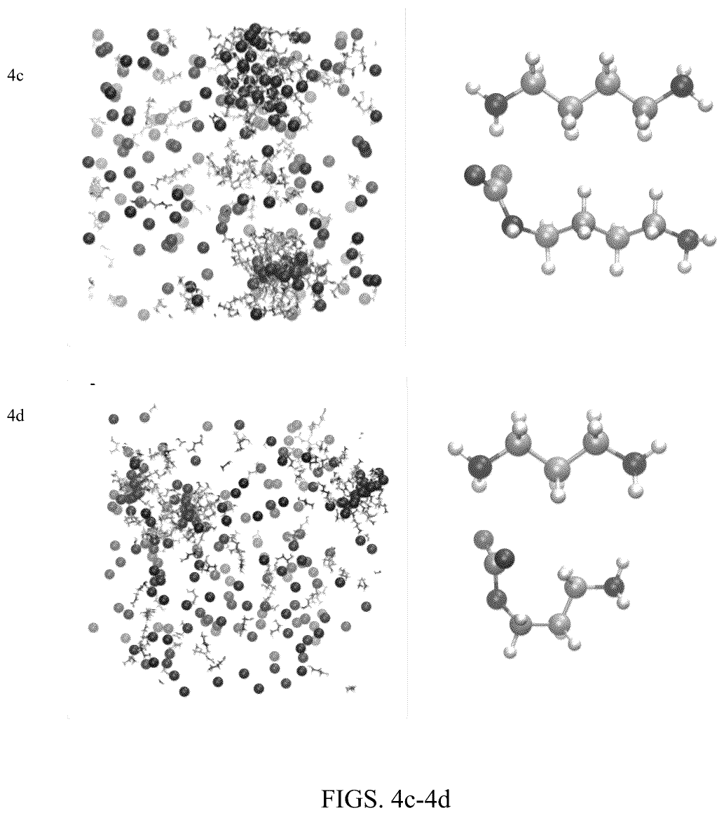

The evolutions of SASA values of amine-carbamate complexes with Na⁺ were studied. From this, it was found that only the SASA of carbamate in the hexane-diamine system appears to slowly decrease compared with the others. This behavior indicates that hexane-diamine and carbamate aggregate together, whereas carbamate molecules mainly aggregate in other systems. To see the difference more clearly, the same simulations were performed with a lower amine concentration (10 wt %) because the complex structural and dynamics differences are not clearly observed at a high amine concentration (30 wt %). FIGS. 4a-4d (left, middle, and right panels for each)) shows the amine-carbamate-Na complex after 20 ns with 10 wt % amine solution. The left panels show both amine and carbamate with Na; the middle panels show only carbamate with Na; the right panels show only amine with Na. As the chain length decreased from hexane (FIG. 4a) to pentane (FIG. 4b) to butane (FIG. 4c) to propane (FIG. 4d), the size of the aggregate also decreased. Most significantly, the hexane-diamine system showed more amine molecules involved in the complex. Carbamate is more likely to be concentrated near Na clusters in all systems. For the hexane-diamine, amines are more concentrated near the complex than in other systems, which is consistent with the SASA analysis of the 30 wt % concentration.

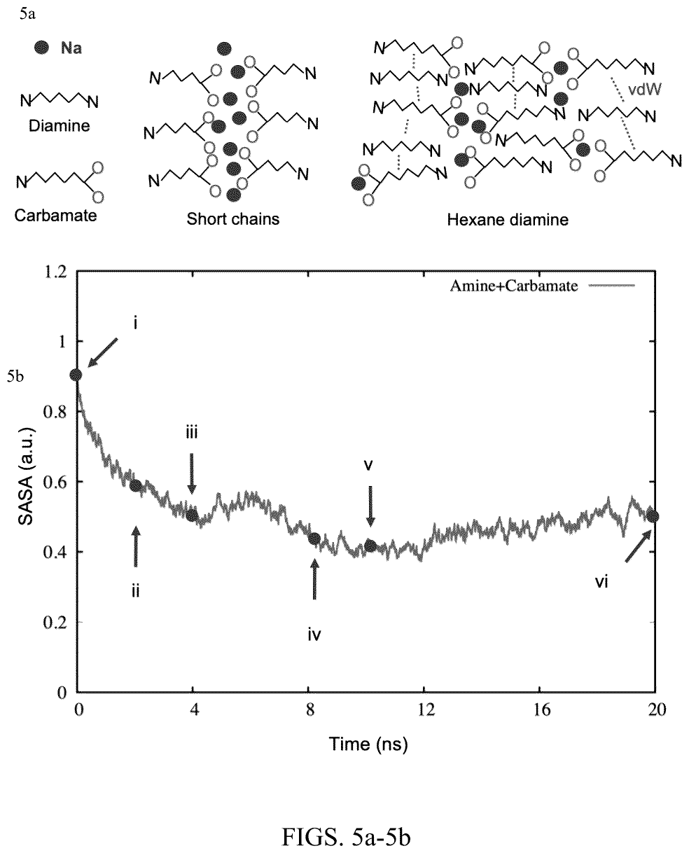

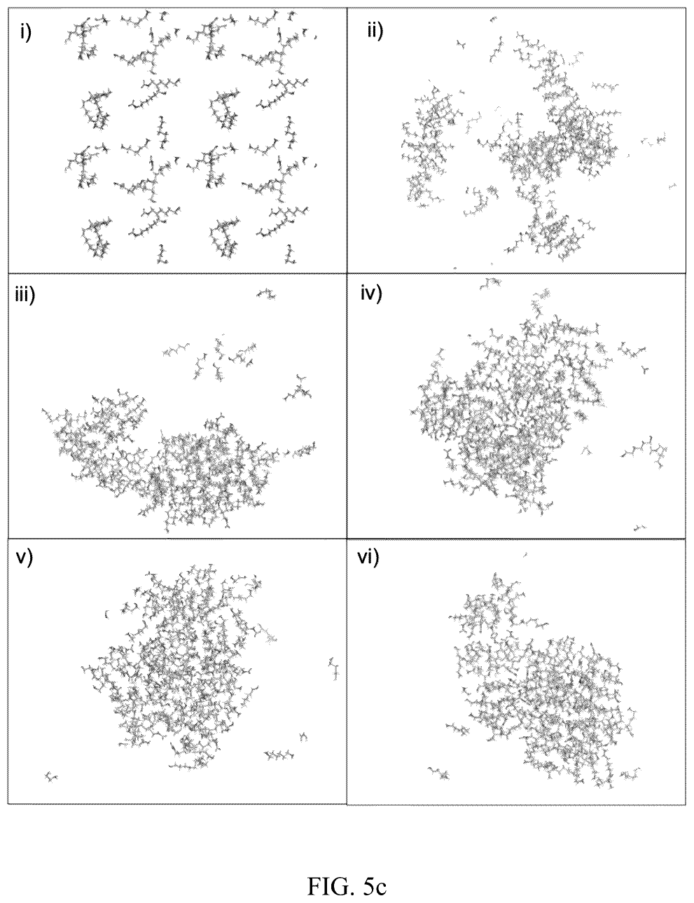

FIG. 5a shows a schematic of the atomic-scale mechanisms in the precipitation of the amine-carbamate-Na complex. The carbamate of short amines can only interact with Na⁺, which is difficult to form a larger-scale cluster. In the hexane-diamine system, carbamate can interact and be stabilized through van der Waals interaction (red dotted lines) with amine molecules. More neutral amine molecules in the complex prevent the electrostatic interactions of Na⁺ and negative oxygen atoms in carbamates from being concentrated, allowing the formation of a larger cluster. Temporal evolution of hexane-diamine and carbamate (10 wt %) with the SASA is shown in FIG. 5b. FIG. 5c shows the corresponding structures in each snapshot of the amine-carbamate complex from the initial configuration, clearly illustrating the clustering dynamics during the MD simulations.

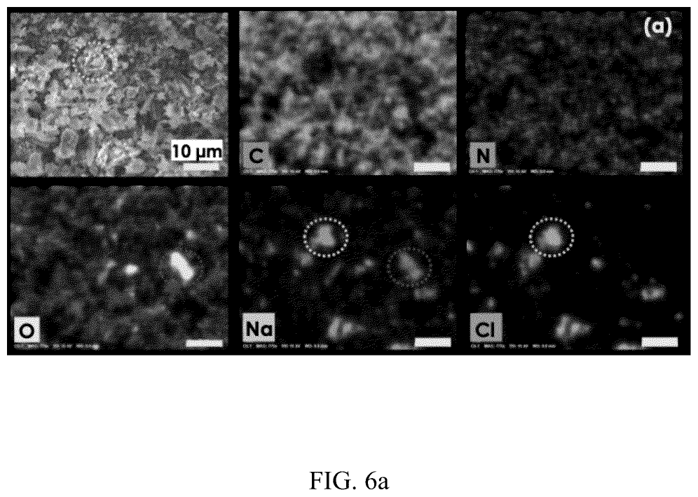

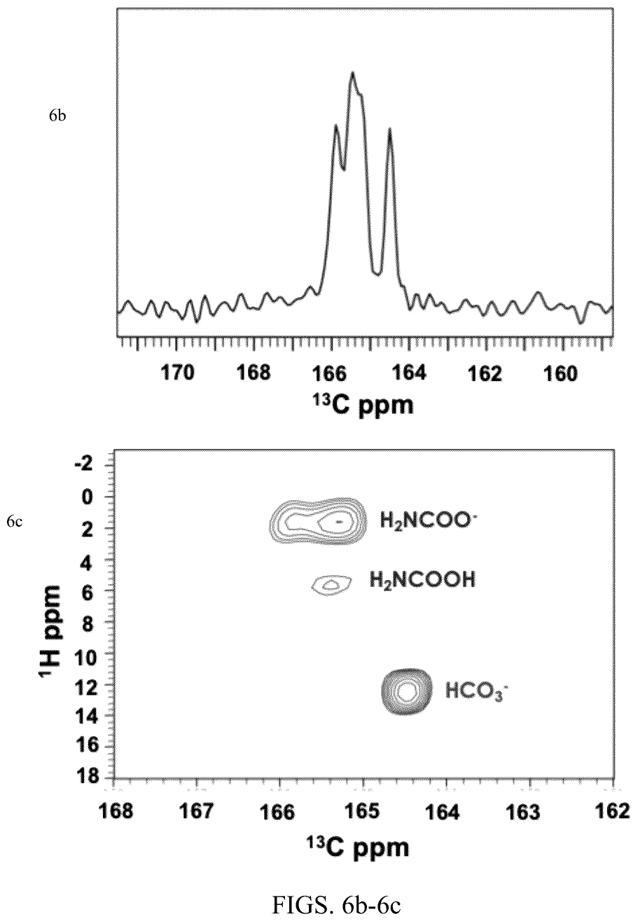

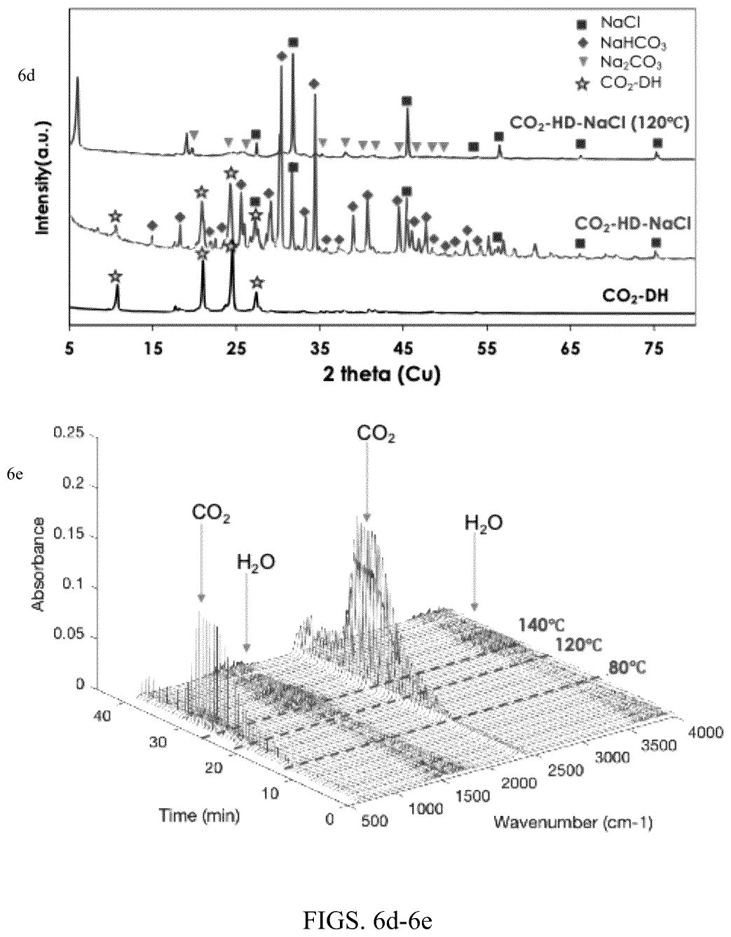

Chemistry of the CO₂-HD-Na complex: The precipitated solid particles contain diamine-carbamate, NaHCO₃, and NaCl. The SEM-EDS micrographs in FIG. 6a show that the chemical composition of the precipitated solid includes carbon, nitrogen, oxygen, sodium, and chlorine (i.e., C, N, O, Na, and Cl, respectively). The red dotted circles indicate NaHCO₃, and yellow dotted circles indicate NaCl. The carbon, nitrogen, and oxygen results reveal a CO₂-reacted HD oligomer containing H₂NCOO⁺ or HCO₃⁻. The presence of carbamate and bicarbonate in the precipitated solid was further quantified using solid 1H and ¹³C NMR. The full ¹³C MultiCP spectra for the CO₂-HD-Na samples were also taken. The spectra are quite similar, both with the amine peak (20-50 ppm) and carbonyl peak (164-166 ppm). FIG. 6b shows carbon spectra of the carbonyl group in the range of 164-166 ppm. The ¹H/¹³C HECTOR NMR spectrum of a CO₂-HD-Na solid specimen is shown in FIG. 6c. The carbonyl region shown in FIG. 6c was used to quantify H₂NCOO⁺, H₂NCOOH, and bicarbonate. The amounts of H₂NCOO⁻/H₂NCOOH and bicarbonate from CO₂-HD-Na were 74% and 26%, respectively. Based on this characterization, carbamate was found to be present in the oligomer. FIG. 6d shows XRD patterns of the dry precipitated solid and annealed solid at 120° C. for 30 min. CO₂-HD solid precipitation without the presence of NaCl could be obtained when 50 wt % HD aqueous solution was loaded with CO₂. The SEM-EDS spectra of solid particles and XRD patterns indicate that the precipitated solid contains NaCl, NaHCO₃, and CO₂-HD after the centrifugal separation process, and NaCl and Na₂CO₃ after regeneration at 120° C. The three crystalline peaks at 11°, 21°, and 24° are associated with organic crystalline material arising from the CO₂-diamine reaction.

When 50 wt % HD aqueous solution was loaded with CO₂ until saturation, the entire solution was solidified without the presence of NaCl. This behavior indicates that a protonated diamine in HD can be solidified with CO₂ at highly concentrated solutions. For example, a carbamate oligomer can be synthesized via the polymerization of HD with CO₂ directly at 180° C. and 11.5 MPa for 6 hours.

By the novel CO₂-HD-Na aggregate synthesis route developed herein, NaHCO₃ forms as a by-product in the present CO₂-HD-Na aggregate reaction. The crystalline structure changed after thermal annealing at 120° C. for 3 hours. The CO₂-HD organic crystalline peaks were not present, and new crystalline peaks occurred at the low angle regimes. Also, the NaHCO₃ was thermally decomposed and new crystalline peaks (i. e., Na₂CO₃) were observed in the annealed powder. In general, NaHCO₃ thermally decomposed to Na₂CO₃ above 120° C. (i. e., 2 NaHCO₃→Na₂CO₃+H₂O+CO₂ at >120° C.). The NaCl peaks were intact after thermal annealing.

The thermal decomposition features of the CO₂-HD-Na aggregate indicate low energy CO₂ regeneration. In situ FTIR spectroscopy, as shown in FIG. 6e, was performed to analyze the exhaust gases from decomposing samples during the TGA/DSC measurement. Significant CO₂ peaks at 500 and 2,500 cm-1 arose with the mass losses around 12 min at 80° C., which correspond to the decomposition of the CO₂-HD. The water peak at 1,500 cm-1 arose around 20 min, corresponding to an annealing temperature to 120° C. This peak may be associated with the decomposition of NaHCO₃ to Na₂CO₃, with H₂O and CO₂ evolution. Notably, the regenerated powder can be recycled. Approximately 80 wt % mass loss occurred via the thermal regeneration at 120° C. for 1 hr, and the content of non-decomposed solid (presumably Na₂CO₃) in the regenerated powder significantly increased with increasing the CO₂ loading. The regenerated CO₂-HD-Na solids were added to the supernatant from the centrifugal solid/liquid separation after aggregate formation, although they were not fully regenerated from CO₂. Adding the regenerated solids (possibly Na₂CO₃, NaCl, and organics) to the supernatant liquid led to solid precipitation again, and this reduced the CO₂ and amine concentration of the new supernatant liquid. The second cycle of precipitated solids fix CO₂ as carbamate and bicarbonate, with a ratio of 5.10±0.14 mmol CO₂/g-sorbent (n=4). The total amount of the second precipitation increases with the increasing amount of regenerated solids. It appears that temperature and other energy input (e. g., sonication) accelerate the kinetics and extent of CO₂-HD-Na agglomeration.

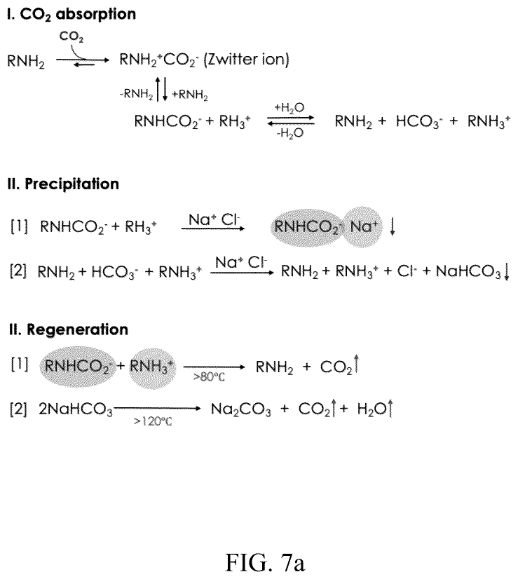

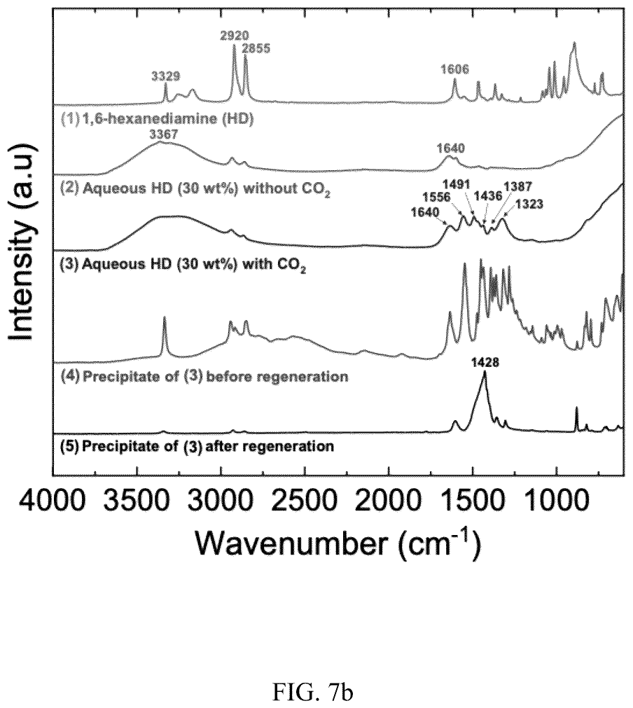

Mechanism of CO₂-HD-Na aggregate formation and regeneration: FIG. 7a illustrates the overall chemical reactions that occur during CO₂ absorption, precipitation, and regeneration at elevated temperatures. When CO₂ is dissolved in the HD/NaCl aqueous solution, zwitterions are generated through the chemical reaction of the primary amine within HD and CO₂. These transient zwitterions then transform into various ionic CO₂ species in the aqueous HD, such as carbamate, carbonate, and bicarbonate. The chemical equilibrium for carbonate/bicarbonate formation is known to be dependent on the pH level of the aqueous solution; as the pH decreases, the system shifts towards the formation of bicarbonate. Since CO₂ acts as a weak acid when dissolved in the aqueous medium, it is expected that the pH level of the diamine/NaCl aqueous system will be relatively lower with the addition of excessive CO₂. Thus, the preferred species formation would be bicarbonate rather than carbonate.

In general, the CO₂ capture process is considered reversible and is controlled by temperature. In this study, CO₂ was regenerated at elevated temperatures. Since the precipitates contain not only Na₂CO₃ but also a significant amount of carbamate induced by the metal aggregation, a two-step decomposition process was observed (as indicated in FIGS. 3a and 3b) for the carbamate and bicarbonate species. The carbamate species can be regenerated at temperatures above 80° C., releasing CO₂, and the NaHCO₃ can be decomposed into Na₂CO₃ at temperatures above 120° C., releasing both CO₂ and water molecules. The Na₂CO₃ can be decomposed to Na₂₀ and CO₂ at 851° C. and used to capture CO₂ in the presence of H₂O to reversibly form NaHCO₃ at <100° C.

To confirm the chemical reactions involved in CO₂ absorption and desorption using the diamine and/or NaCl solution, FTIR analysis was conducted on samples of neat HD, aqueous HD with and without CO₂, and CO₂-containing precipitate before and after regeneration, with the results shown in FIG. 7b. Neat HD has two amine groups at the opposite ends of its aliphatic backbone. Spectrum (1) in FIG. 7b shows that two characteristic amine peaks were observed at 3,329 and 1,606 cm-1 due to nitrogen-hydrogen stretching and hydrogen-nitrogen-hydrogen bending (P. Jackson et al., Greenhouse Gas Control Technologies, 9, 985, 2009). Additionally, two strong peaks of symmetric and asymmetric aliphatic stretching were recorded at 2,932 and 2,863 cm-1 (S. Jiang et al., Green Energy & Environ., 2, 370, 2017). The FTIR spectra of aqueous HD in spectrum (2) of FIG. 7b show two characteristic peaks of oxygen-hydrogen stretching and its overtone at 3,368 and 1,638 cm-1 due to water (P. Jackson et al., Ibid.). The addition of CO₂ to the aqueous HD created new peaks at 1,300-1,600 cm-1 in spectrum (3) of FIG. 7b due to the formation of carbamate at 1,556 and 1,492 cm-1, and of bicarbonate at 1,491, 1,388, and 1,321 cm-1. (Li Q. et al., Front. Energy Res., 3, 53, 2016). Spectrum (4) in FIG. 7b shows clear attribution of carbamate and bicarbonate in the CO₂-containing precipitate with minimal water peaks. Furthermore, characteristic HD peaks were detected, as well, because of the carbamate compound induced by the metal aggregation. With the CO₂-containing precipitate heated at 120° C. for 4 hours, spectrum (5) in FIG. 7b clearly shows a strong peak of Na₂CO₃ at 1,428 cm-1, thus supporting the conclusion that one of components in the precipitate before heating was NaHCO₃(S. Jeong et al., Packag. Technol. Sci. 30, 781, 2017).

### CONCLUSIONS

A novel approach for solid CO₂ fixation by NaCl was investigated in various diamine molecular systems. Low thermal regeneration of solid sorbents was demonstrated using CO₂-hexane-diamine-Na solid particles, which can be easily separated from the aqueous solvent. Carbamate diamine molecules, after capturing CO₂ and Na⁺, chelate to form large molecular networks. Then, multiple chemical reactions occur to form a Na⁺-induced carbamate oligomer and NaHCO₃, thus resulting in solid precipitation. Systematic MD simulation revealed that the interaction between carbamate and unreacted hexane-diamine molecules can be aggregated by van der Waal forces, in contrast to smaller diamine molecules. The neutral amine molecules in the carbamate-diamine-Na aggregate prevent electrostatic interactions of Na⁺ and negative oxygen atoms in carbamates, thereby promoting the formation of larger clusters. As a potential breakthrough strategy for thermal energy reduction in CO₂ capture, the separated solid sorbent releases the absorbed CO₂ with a relatively low heat requirement.

While there have been shown and described what are at present considered the preferred embodiments of the invention, those skilled in the art may make various changes and modifications which remain within the scope of the invention defined by the appended claims.

What is claimed is:

1. A method for capturing carbon dioxide, the method comprising:
(i) contacting carbon dioxide gas with an aqueous solution comprising: (a) an aqueous solvent, (b) an amine-containing molecule of the formula H₂N—(CR₂)ₙ—NH₂, wherein n is an integer of 3-12 and R is independently selected from H, CH₃, CH₂CH₃, (CH₂)ₘOH, and (CH₂)ₚNH₂ for each instance of R, wherein m and p are independently selected from 0-3; and (c) a monovalent or divalent metal salt of the formula M^{a}_{c}X^{b}_{d} where M is a monovalent or divalent metal, X is an anion other than carbonate or bicarbonate, a is +1 or +2, b is −1 or −2, and a·c=b·d; wherein the contacting step results in precipitation of a complex carbamate salt of the formula H₂N—(CR₂)ₙ—NHC(O)O⁻M^{a} and/or a complex dicarbamate salt of the formula M^{a-}O(O)CHN—(CR₂)ₙ—NHC(O)O⁻M^{a}; and
(ii) separating the precipitated complex carbamate and/or dicarbamate salt from the aqueous solvent.

2. The method of claim 1, wherein the precipitated complex carbamate salt further contains an ammonium bicarbonate salt of the formula H₂N—(CR₂)ₙ—NH₃⁺(HCO₃⁻), and/or a metal bicarbonate salt of the formula M^{a}(HCO₃⁻)_{d}, wherein a=d.

3. The method of claim 1, further comprising the following step, after step (ii):
(iii) subjecting the precipitated complex carbamate and/or dicarbamate salt to an elevated temperature of at least 80° C. and up to 200° C., to result in regeneration of the amine-containing molecule and simultaneous release of the captured carbon dioxide, wherein the released carbon dioxide is quarantined to prevent release into the atmosphere.

4. The method of claim 3, wherein the elevated temperature is at least 80° C. and up to 120° C.

5. The method of claim 1, wherein the amine-containing molecule has the formula H₂N—(CH₂)ₙ—NH₂, wherein n is an integer of 3-8.

6. The method of claim 1, wherein the amine-containing molecule is selected from one or more of the group consisting of 1,3-diaminopropane, 1,4-diaminobutane, 1,5-diaminopentane, and 1,6-diaminohexane.

7. The method of claim 1, wherein the monovalent or divalent metal M is an alkali metal.

8. The method of claim 7, wherein the alkali metal is sodium (Na⁺) or potassium (K⁺).

9. The method of claim 1, wherein the anion X is selected from the group consisting of halide, sulfate, and nitrate.

10. The method of claim 1, wherein the anion X is chloride or bromide.

11. The method of claim 1, wherein the amine-containing molecule is present in the aqueous solution in a concentration of 5-60 wt %.

12. The method of claim 1, wherein the amine-containing molecule is present in the aqueous solution in a concentration of 5-40 wt %.

13. The method of claim 1, wherein the amine-containing molecule is present in the aqueous solution in a concentration of 10-60 wt %.

14. The method of claim 1, wherein the amine-containing molecule is present in the aqueous solution in a concentration of 10-40 wt %.

15. The method of claim 1, wherein the monovalent or divalent metal salt is present in the aqueous solution in a concentration of 1-120 g/L.

16. The method of claim 1, wherein the monovalent or divalent metal salt is present in the aqueous solution in a concentration of 1-60 g/L.

17. The method of claim 1, wherein the monovalent or divalent metal salt is present in the aqueous solution in a concentration of 5-60 g/L.

18. The method of claim 1, wherein said carbon dioxide gas is within a waste stream making contact with the aqueous solution.

19. The method of claim 1, wherein the contacting step (i) is achieved by forming a precursor solution containing components (a) and (b), contacting the carbon dioxide gas with the precursor solution, followed by addition of component (c) to the precursor solution.

20. The method of claim 1, wherein the contacting step (i) is achieved by forming a precursor solution containing components (a) and (c), contacting the carbon dioxide gas with the precursor solution, followed by addition of component (b) to the precursor solution.

21. The method of claim 1, wherein the contacting step (i) is achieved by contacting the carbon dioxide with a pre-made aqueous solution containing components (a), (b), and (c).
